(19) United States
(12) Patent Application Publication
(10) Pub. No.: US 2009/0289041 A1
(43) Pub. Date: Nov. 26, 2009

(54) ELECTRIC JOINING METHOD AND ELECTRIC JOINING APPARATUS

(76) Inventors: Takeshi Tsukamoto, Hitachinaka (JP); Tadashi Kasuya, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/537,032

(22) Filed: Aug. 6, 2009

Related U.S. Application Data
(63) Continuation of application No. 11/494,703, filed on Jul. 28, 2006.

(30) Foreign Application Priority Data
Jul. 29, 2005 (JP) 2005-219856

(51) Int. Cl. B23K 11/11

(52) U.S. Cl. 219/91.2; 219/86.23

(57) ABSTRACT

A resistance bonding method comprises contacting a plurality of bonding members, which are electro-conductive, supplying current to the bonding members under a stress applied to a contact interface therebetween by means of plural electrodes in contact with the bonding members thereby to bond the members. The current supply is conducted by switching energizing paths. Part of the members is thermally expanded by current supply before one of the bonding members is contacted with other member, and the members in contact with each other are bonded by the second current supply.

### CROSS REFERENCE TO RELATED APPLICATION

This application is a continuation application of application Ser. No. 11/494,703 filed Jul. 28, 2006, the disclosure of which is herein incorporated by reference.

### CLAIM OF PRIORITY

The present application claims priority from Japanese application serial No. 2005-219856, filed on Jul. 29, 2005, the content of which is hereby incorporated by reference into this application.

### DESCRIPTION OF INVENTION

1. Field of Invention

The present invention particularly relates to a resistance bonding method and a resistance bonding apparatus.

2. Background Art

Among joining methods of metallic materials, a diffusion bonding method is carried out wherein current supply is conducted under a stress applied to members whereby materials are heated by joule heat caused by electric resistance at bonding interfaces and electric resistance in the inside of the materials. Accordingly, energy efficiency is high and bonding time is short. The diffusion bonding brings about diffusion of atoms in the bonding members at the interface of the members, which are closely contacted with each other. The diffusion of atoms should be enough to form bonding between the members. From these advantages, the methods are widely used in automobile industries, etc. In these methods utilizing continuous DC electricity supply or DC electricity pulse supply, they are called a continuous electric current diffusion bonding method, a pulse electric current diffusion bonding method, a pulse electric current bonding method, a sparked plasma diffusion method, a sparked plasma bonding method, etc. The following document discloses an example of conventional diffusion bonding methods.

Patent document 1: Japanese patent laid-open 2002-59270

In the conventional resistance bonding methods, since current supply is carried out while a pair of electrodes is pressed towards a bonding interface by means of a pressing mechanism, a pressing direction and a current supply direction are the same. Accordingly, when members having bonding interfaces each having a different direction of normal line are bonded, a resistance bonding apparatus provided with a plurality of pressing mechanisms for a pair of electrodes each having a different press axis. It is very difficult to construct such complicated apparatuses.

In case where butting faces of a member 9 having a hole and an insert member 10 to be inserted into the hole to form a butting face as shown in FIG. 7 are bonded, it is almost impossible, from the practical point of view, to perform that the bonding interface is pressed by means of an external pressing mechanism to bring them into contact, while supplying current. Accordingly, the resistance bonding method cannot be applied to the mentioned-above members.

### SUMMARY OF THE INVENTION

It is an object of the present invention to provide an electric joining method of resistance bonding, which is capable of electric resistance bonding of members having complicated structures, which have plural bonding interfaces of directions or of members having bonding interfaces inside thereof to which bearing stress cannot be imparted by an external pressing device.

A feature of the present invention that achieves the object resides in that the method comprises a step for switching energizing paths during resistance bonding. More concretely, the bonding method of the present invention is featured by that the pressing direction and the current supply direction are not in the same direction.

### BRIEF DESCRIPTION OF DRAWINGS

FIG. 1 (A) is a diagrammatic view of a first embodiment showing a state of current supply start.

FIG. 1(B) is a diagrammatic view of the first embodiment showing a state of switching energizing paths by means of a current path switching mechanism, which is built in the power source 3.

FIG. 2(A) is a diagrammatic view of a second embodiment showing a state of current supply start.

FIG. 2(B) is a diagrammatic view of the second embodiment showing a state of switching energizing paths by means of a current path switching mechanism built in the power source 3.

FIG. 3(A) is a diagrammatic view of a third embodiment showing a state of current supply start.

FIG. 3(B) is a diagrammatic view of the third embodiment showing a state of switching energizing paths by means of a current path switching mechanism built in the power source 3.

FIG. 4 is a diagrammatic view of a fourth embodiment.

FIG. 5 is a diagrammatic view of a fifth embodiment.

FIG. 6(A) is a diagrammatic view of a sixth embodiment showing a state of current supply start.

FIG. 6(B) is a diagrammatic view of the sixth embodiment showing a state that a shear press mold moves thereby to cause shear deformation at a superimposed portion of the members.

FIG. 7 is a perspective view showing plural members to be bonded.

FIG. 8 is a diagrammatic view showing a resistance bonding method for plural members.

In the drawings, there are following representative reference numerals.

1; denotes electrode, 2; energizing path, 3; power source electrode, 4; energizing path switching mechanism, 5; bonding interface, 6; contact resistance detecting means, 7; shaft member, 8; outer parts, 9; member having a hole, 10; insert member, 11; pressing tool, 12; insulator, 13; stepped member, 14; temperature measuring means, 15; butt member of A2618, 16; butt member of AZ91, 17; holder, 18; space for plastic deformation, 19; fixer, 20; plate member, 21; shear press mold, 22; pressing direction, 23; members having different diameters, 24; contact interface between electrode 1 and the members 23 having different diameters.

### DETAILED DESCRIPTION OF PREFERRED EMBODIMENTS

One aspect of the present invention related to a resistance bonding method wherein a plurality of members are contacted and current is supplied between the members thereby to bond the members by heating them due to resistance heat. The current supply is carried out by DC electricity, AC electricity, DC pulse electricity, alternate pulse current or combinations thereof. The resistance heat is generated in the contact interface or in the inside of the members.

Another aspect of the present invention provides a method wherein at least one electrode is contacted with one member of plural members to be bonded thereby to contact bonding interfaces of the members, holding the members by the electrode or a holding mechanism; and energizing paths between the electrodes are switched to perform the resistance bonding.

A still another aspect of the present invention provides a resistance bonding method wherein at least one electrode is contacted with one of the members in such a manner that the bonding interface of each of the members faces to each other by holding the electrode or a holding mechanism, the members in the current supply paths are heated thereby to closely contact the members due to thermal expansion, and a state that a pair of electrodes in a condition that they are in electric conductivity is detected, whereby the energizing paths are switched among the electrodes.

The first to third aspects of the present invention can be preferably conducted wherein the members are bonded in a solid state. Further, The pressing of the members for bonding is performed by a pressing mechanism for applying a bearing stress to a contact interface between the members, the pressing mechanism being independent from the power source.

A still another aspect of the present invention provides a resistance bonding method wherein a circumference of a contact interface of the members to be bonded is surrounded by a mold having a groove, which is formed at a butting side of the members, with a predetermined contour; at lest one electrode is contacted with one member; a bearing stress is applied to the contact interface between the members by means of an electrode provided with a pressing mechanism or a pressing mechanism independent from the electrode; the members are heated by supplying current in a energizing path, which passes through the contact interface; and softened material of the members in the contact portion is plastic flow into the groove thereby to bond them in a solid state.

A further aspect of the present invention provides a resistance bonding method wherein the members to be bonded are of plates, and the plates of which bonding portions are stacked are sandwiched between press molds arranged opposite to each other; at least one of the electrodes is contacted with one of the members; the members in energizing path are heated by supplying current that passes through the stacked faces; and softened material of the stacked members is deformed in shearing under pressing by the press mold.

Another aspect for achieving the object of the present invention provides a resistance bonding method wherein current supply to electro-conductive members, which are in contact with each other, is conducted thereby to heat the members by resistance heat generation from the contact interfaces and inner resistance to bond the members.

The power supply for current supply may use DC electricity, AC electricity, DC pulse electricity, alternate pulse current or combinations thereof.

A still another aspect of the present invention provides a resistance bonding apparatus comprising at least three electrodes for supplying current to electro-conductive members, a holding mechanism for holding the embers, coupled to the electrodes or independent from the electrodes, detecting means for detecting a electric conductivity between the electrodes, a power supply connected to the electrodes for supplying current, and a switching mechanism for switching the energizing paths among the electrodes, wherein the bonding is performed while switching the energizing paths among the electrodes.

A further aspect of the present invention provides a resistance bonding apparatus comprising a plurality of electrodes in contact with electro-conductive members for current supply, measuring means for measuring temperature of a surface of the members under electric conductivity, a pressing mechanism, independently from the electrodes, for applying a bearing stress to contact interfaces of the members, and a power supply, connected to the plural electrodes, for supplying current, a heating temperature of the members being controlled to be a temperature lower than a solid phase line to perform bonding.

A still further aspect of the present invention provides a resistance bonding apparatus comprising a plurality of electrodes in contact with electro-conductive members for supplying current, measuring means for measuring temperature of a surface of the members under electric conductivity, a mold having a groove of a predetermined contour at a butting side of the members to be bonded, pressurizing means, independent from the electrodes or coupled to the electrodes, for applying a bearing stress to the contact interface of the members, and a power supply connected to the electrodes for supplying current to the electrodes, which further comprises a control device for controlling the temperature of the members to be lower than the solid phase temperature wherein the members in a energizing path are heated by supplying current that passes through the contact interface, and a plastic deforming device for plastically deforming part of softened material of the contact portion of the members thereby to cause the material flow into the groove.

A still further aspect of the present invention provides a resistance bonding apparatus comprising a plurality of electrodes in contact with electro-conductive members, a pair of press molds, opposite to each other with a bonding portion of the plate form members, for applying shear deformation to the bonding portion, a pressing mechanism for pressing the press mold towards the bonding portion of the plate form members, and a power supply connected to the electrodes for supplying current to the electrodes, wherein the members in a energizing path are heated by supplying current that passes through the contact interface between the electrodes thereby to shearing-deform a stacked portion of the softened members to bond the members.

### EMBODIMENTS

In the following embodiments of the present invention will be explained by reference to drawings.

### (Members)

In the following embodiments, materials used in the embodiments are not limited unless otherwise explained. The present invention can be applied to bonding of other electro-conductive materials. The members to be bonded may be the same or different materials. The members may be divided into several parts as long as electric conductivity of them is kept electro-conductive as a whole. In other words, another member such as blaze metals may be sandwiched in the bonding interface and bonding is performed at two or more positions.

### (Bonding Temperature)

Although the temperature for bonding should preferably be lower than the solid phase line of the members to be bonded, bonding is performed even if there is a slight fusion at the bonding interface, as long as a sufficient bearing stress necessary for bonding is present at the bonding interface. A means that monitors the temperature of the members appropriately for controlling a temperature of the members to prevent the temperature higher than a predetermined temperature may be provided. The temperature of the members may be judged by the temperature measured by means of contact- or non contact-type temperature measuring means such as thermocouples or radiation thermometers or a measured value of contact resistance between the electrodes.

By controlling the bonding temperature to be lower than the solidus temperature, it is possible to suppress a structure change of the materials, such as metallographic structure of ultra fine grain steels. In bonding of metallic glass comprising metal and ceramics such as glass, a preferable bonding temperature is lower than the temperature of crystallization so as to prevent crystallization of the glass phase.

### (Current Supply Means)

The power supply may be ones to which electric power is supplied or ones which generate electric power inside. Supplied current may be DC electricity, AC electricity, DC electricity pulse current, AC electricity pulse, or combinations thereof. Directions of current may be opposite to each other.

### (Pressurizing Means)

Movable type pressurizing means may use pneumatic type, hydraulic type, electric motor-driven type, spring type, or gravity type that uses weight of the members. When the electrodes are contacted with the members and are held to use as the pressurizing means, the pneumatic type, hydraulic pressure type, electric motor type, spring type, electrode gravity type pressurizing means may be used.

AS described in the following embodiments, the electrodes may be provided with a pressing function.

### Embodiment 1

As a first embodiment, bonding of plural members having plural bonding interfaces of different directions was performed by contacting and holding the bonding members with the plural electrodes, without using a pressing mechanism for pressing the bonding interfaces, as follows.

At first, the members were heated and thermally expanded by supplying current in a energizing path that does not goes through the bonding interface, thereby to sufficiently contact the bonding interfaces of the members. Then, the members were bonded by supplying current that passes through the bonding interfaces, while switching the energizing paths.

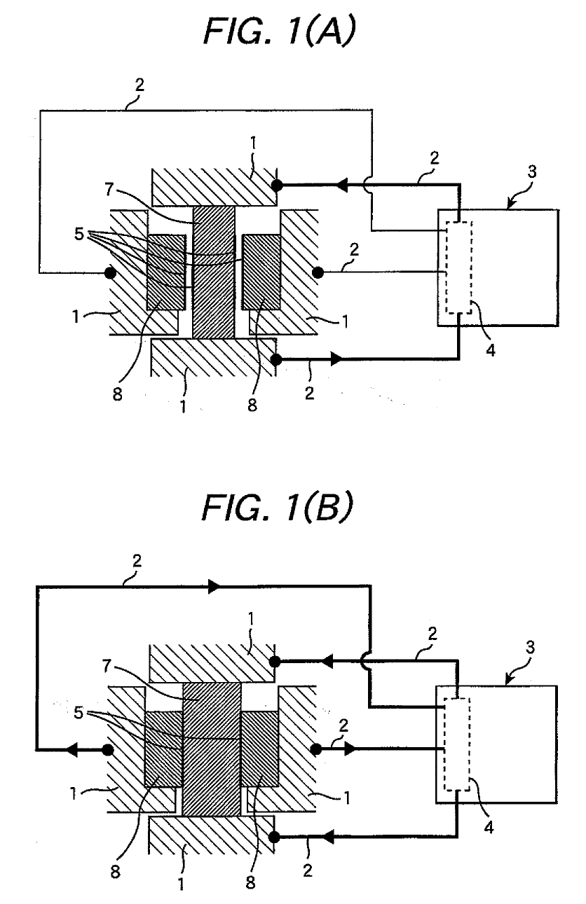

FIGS. 1 (A) and (B) show the first embodiment, wherein the plural bonding members, which are electro-conductive have plural bonding interfaces each having a different direction, electrodes and power supply and energizing paths. The bonding members and electrodes are shown by a cross sectional view. In this embodiment, SUS 403 was used as the bonding members.

The reference numeral 1 denotes electrodes, 2 energizing paths, 3 a power source, 4 a current flow path switching mechanism, 5 bonding interfaces, 7 a shaft member, and 8 outer parts. The drawings show sectional views of bonding members and electrodes. Arrows in the drawings indicate directions of current in the energizing paths 2.

FIG. 1 (A) shows the state of current supply start. The shaft member 7 and the outer parts 8 are held in a state the bonding interfaces 5 are in contact by the fixed electrodes 1. The shaft member 7 has an axis extending vertical direction of FIG. 1 (A) Although only two of the outer parts 8 are shown in FIG. 1 (A), there are four constituting members 8 in total surrounding the shaft member 7. All of the constituting member 8 are held by electrodes 1. At this stage, since the bonding interfaces 5 of the bonding members are not imparted with pressure, a contact condition of the bonding interfaces is not sufficient.

At the state of current supply start, current is supplied from the electrode 1, which is located above the shaft member 7 through the shaft member 7 to the electrode 1 at the bottom. The shaft member generates heat due to inner electric resistance to thermally expand. At the same time, since the outer parts 8 are restricted or held by the electrodes 1, a bearing stress generates in the bonding interfaces between the shaft member 1 and the outer parts 8. By this bearing stress, the energizing paths 2 are switched after the contact condition of the bonding interfaces is homogeneous.

FIG. 1 (B) shows a state after switching of the energizing paths by the energizing path switching mechanism 4 built in the power supply 3. Current is supplied to the electrode 1 in contact with the outer parts 8 from the electrodes 1 positioned upper and lower positions of the shaft member 7. Resistance heat generation takes place at the bonding interface 5 where the bonding members are contacted thereby to heat the bonding members to a predetermined bonding temperature, which is lower than the solidus temperature of the material of the bonding members. A diffusion bonding in the solid state is carried out by a pressure appeared by thermal expansion of the members in the bonding interfaces and heating the members by current flow. After bonding, sectional areas of the bonding interfaces were observed, and it was revealed that there were no voids in the bonding interfaces and good bonding was obtained.

This embodiment has such advantages that this can be applicable to the bonding members have bonding interfaces each having different direction, and the bonding members having the bonding interfaces inside of the members to which a bearing stress is not applied to the bonding interface by an external pressurizing means. Further, in this embodiment, since the electrodes are independent from the pressurizing means, it is possible to change arrangement of electrodes, shape of electrodes, etc in accordance with the shape of the bonding members.

### Embodiment 2

As a second embodiment, bonding of a member having a hole and another member, which is inserted into the hole thereby to bond the contact face, was performed. The other electrodes were in contact with the member having the hole. At first, current was supplied between the electrodes that hold the member to be inserted to heat it to effect thermal expansion thereby to closely contact with the inner face of the hole of the other member. Then, the energizing path was switched to an energizing path for supplying current to the electrode in contact with the member having the hole so that the electrodes that hold the members to be inserted through the bonding interface of the members supplied the current for bonding.

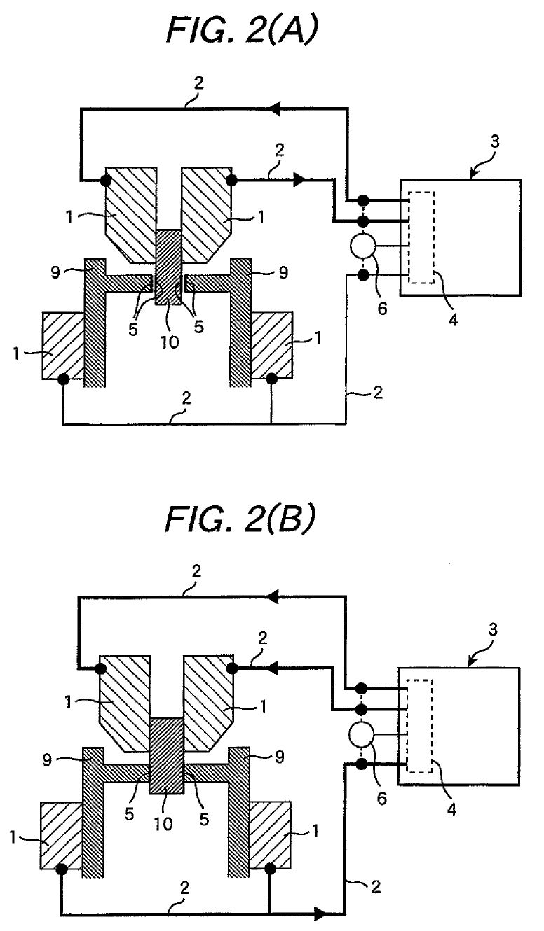

FIGS. 2(A) and 2(B) show the second embodiment wherein bonding members, electrodes, power source and energizing paths, wherein one of the bonding member has a hole into which the other member is inserted to form contact face for bonding. The bonding members and the electrodes are shown in cross sections.

In this embodiment, the member having the hole is made of single crystal of nickel based alloy CMSX-4, and the member to be inserted is made of ordinary cast material of nickel based alloy Inconel 738LC. The reference numeral 1 denotes electrodes, 2 energizing paths, 3 a bonding power source, and 4 the energizing path switching mechanism, 5 the bonding interfaces, 6 the contact resistance detecting means, 9 the member having the hole and 10 the member to be inserted. These figures show cross sections of the bonding members and the electrodes. The arrows in the figures indicate directions of current in the energizing paths.

FIG. 2 (A) shows the state of current supply start. The member 10 to be inserted is inserted into the member 10 having the hole to form a bonding interface 5, the members being held by the two electrodes 1. The gaps between the bonding interfaces of the bonding members are controlled to be predetermined values.

On the other hand, the member having the hole is provided with the plural electrodes 1 in contact therewith. Although only two of the electrodes 1 in contact with the member 9 having the hole are shown, other electrodes are arranged along the circumference of the member 9 having the hole. At the start of current supply, current is supplied between two electrodes 1 that hold the member 10 to be inserted. The member 10 to be inserted is heated by internal thereby to thermally expand. As a result, a bearing stress is imparted in the bonding interface 5 between the member 10 to be inserted and the member 9 having the hole. By this bearing stress, switching of the energizing path 2 is performed after the contact condition in the contact interface 5 is made homogeneous. The contact condition of the bonding interface 5 is judged by resistance values obtained by the resistance detecting means 6.

FIG. 2(B) shows a state after switching of the energizing paths by the energizing path switching mechanism 4, which is built in the power source 3. Current is supplied from the electrode 1 for holding the member 10 to be inserted to the electrode 1 in contact with the member 9 having the hole, thereby to generate resistance heat at the contact interface of the members. The bonding interfaces of the members are heated to a predetermined bonding temperature, which is lower than the solidus temperature of the members. A pressure generated in the bonding interface by thermal expansion of the members and heating the bonding interface by current supply carry out the diffusion bonding in the solid state. After the bonding, it was revealed that the bonding interface had no gaps and was well bonded in accordance with observation of the cross section of the bonding interfaces.

In this embodiment, the members to be bonded were CMSX-4 and Inconel 738LC; other electro-conductive materials can be used, too. The number of the member 10 to be inserted and the hole may be more than one. When they are plural, the switching of the energizing paths is carried out after the contact between all the members to be inserted and the holes becomes sufficient. Though the timing of the switching of the energizing paths is effectively judged by measured values of contact resistance between the electrodes, it is possible to judge from member temperatures measured by a contact type thermometers non-contact type thermometers such as thermocouples, radiation thermometers, etc. Holding of the electrodes in contact with the member 9 having the hole and holding of the member 10 to be inserted by the electrodes 1 can employ pneumatic pressure type, hydraulic pressure type, electric motor type, spring type pressurizing means.

This embodiment can be applied to diffusion bonding methods where there are plural bonding interfaces each having a different direction with respect to the bonding members or a bearing stress cannot be applied to the bonding interface by external pressurizing means because the bonding interface is present inside the bonding members.

Further, in this embodiment arrangement of the electrodes is changed in accordance with the contours of the bonding members because the electrodes are independent from the pressing mechanism.

### Embodiment 3

### (Bonding Utilizing Thermal Shrinkage)

In the third embodiment, a bonding member is inserted into a hole formed in another bonding member. The bonding member to be inserted was held by a pair of the electrodes; the plural electrodes were contacted to the bonding member having a hole, which is slightly smaller than the bonding member to be inserted. At first, the bonding member having the hole was heated and thermally expanded by supplying current from the electrodes in contact with the bonding member thereby to enlarge the diameter of the hole to be larger than the size of the bonding member to be inserted. Then, the bonding member was inserted into the hole to face the bonding interfaces of the members, followed by stopping of the current supply. After closely contacting the bonding member with the inner surface of the hole by cooling and thermal shrinkage of the bonding member having the hole, a energizing path was switched to a energizing path where current was supplied from the electrodes holding the bonding member to be inserted to the electrodes in contact with the bonding member having the hole so as to pass through the bonding interface of the bonding members.

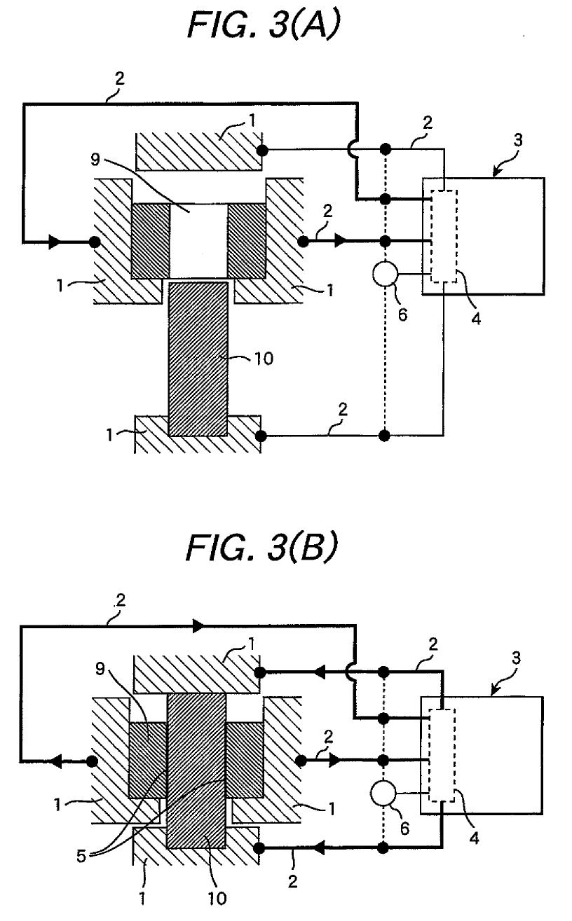

FIGS. 3(A) and 3(B) show the third embodiment comprising the bonding members for bonding the butting faces formed by inserting the bonding member into the bonding member having the hole, electrodes, power supply and energizing paths. The bonding members and electrodes are shown in cross sections. In this embodiment, the bonding member having the hole was SKD61 and the bonding member to be inserted was SUS420J2.

The reference numeral 1 denotes electrodes, 2 energizing path, 3 power source, 4 energizing path switching mechanism, 5 bonding interface, 6 contact resistance detecting means, 9 bonding member having the hole, and 10 the bonding member to be inserted.

Arrows in the drawings are directions of current in the energizing path 2.

FIG. 3 (A) shows a state of current supply start. The bonding member 10 is held by the electrodes 1. On the other hand, the plural electrodes are contacted with the bonding member 9 having the hole. The size of the hole is smaller than the size of the bonding member 10 to be inserted by a predetermined size. The bonding members are shown in cross sections; only two of the electrodes 1 are shown, but there are other electrodes 1 arranged along the surface of the member having the hole. At the time of current supply start, current is supplied between the electrodes in contact with the bonding member having the hole.

Since the bonding member having the hole generates heat by internal electric resistance and thermally expands, the size of the hole becomes larger than that of the bonding member 10 to be inserted. At this stage, the bonding member 10 is inserted into the hole to oppose faces of the bonding interfaces and the bonding member 10 is supported by the upper and lower electrodes.

Upon stopping the current supply to the bonding member 9, the bonding member 10 and the inner face of the hole of the bonding member 9 contact to generate bearing stress due to cooling and thermal shrinkage. The contact between the bonding member 9 and the bonding member 10 is made homogeneous by the bearing stress, and the energizing paths are switched.

The contact state is judged by a contact resistance value measured by the contact resistance detecting means 6. FIG. 3(B) shows the state after the switching of the energizing path 2 by means of the energizing path switching mechanism 4, which is built in the power supply 3.

Current was supplied from the upper and lower electrodes 1 supporting the bonding member 10 to be inserted to the electrodes 1 in contact with the bonding member 9 thereby to generate heat due to electric resistance at the bonding interface 5 where the bonding members are in contact so as to heat the members to a predetermined bonding temperature lower than the solid phase line. The stress that appeared in the bonding interface 5 due to partial thermal expansion in the bonding portion and heating of the bonding portion by current supply make it possible to diffusion bonding under a solid phase state. After bonding, observation of the cross section of the bonding interfaces revealed that the bonding interfaces had no gaps and were well bonded.

In this embodiment, the bonding member were SKD61 and SUS420J2, but other kinds of electro-conductive materials are employed. The number of the bonding members and the holes can be more than one, wherein the switching of the energizing paths is done after the close contact between the all bonding members and the holes is confirmed. The timing of switching of the energizing paths may be judged in accordance with measured values such as temperatures of members measured by contact type or non-contact type temperature measuring means or contact resistance.

This embodiment can be applied to resistance bonding methods where there are plural bonding interfaces each having a different direction with respect to the bonding members or a bearing stress cannot be applied to the bonding interface by external pressurizing means because the bonding interface is present inside the bonding members.

Further, in this embodiment arrangement of the electrodes is changed in accordance with the contours of the bonding members because the electrodes are independent from the pressing mechanism.

### Embodiment 4

As shown in FIG. 8, when an area of a contact interface 24 between the electrodes 1 and different diameter members 23 having different diameter portions is smaller than an contact area 5 between the members 23, the contact interfaces between the electrodes 1 and the members 23 may be adhered by welding because of a large current density, which leads to large heat generation in the contact interfaces during heating the bonding portion in the conventional resistance bonding method.

In a fourth embodiment, bonding members having a large cross sectional area change were bonded by a diffusion bonding method. The electrodes and the pressing mechanism were separated By changing a contact position and contact area between the bonding members and the electrodes and changing a contact position and a contact area between the pressing mechanism and the bonding members, a temperature of the bonding portion were maintained to be higher than temperatures of other portions thereby to carry out the diffusion bonding, without causing partial melting of the bonding members.

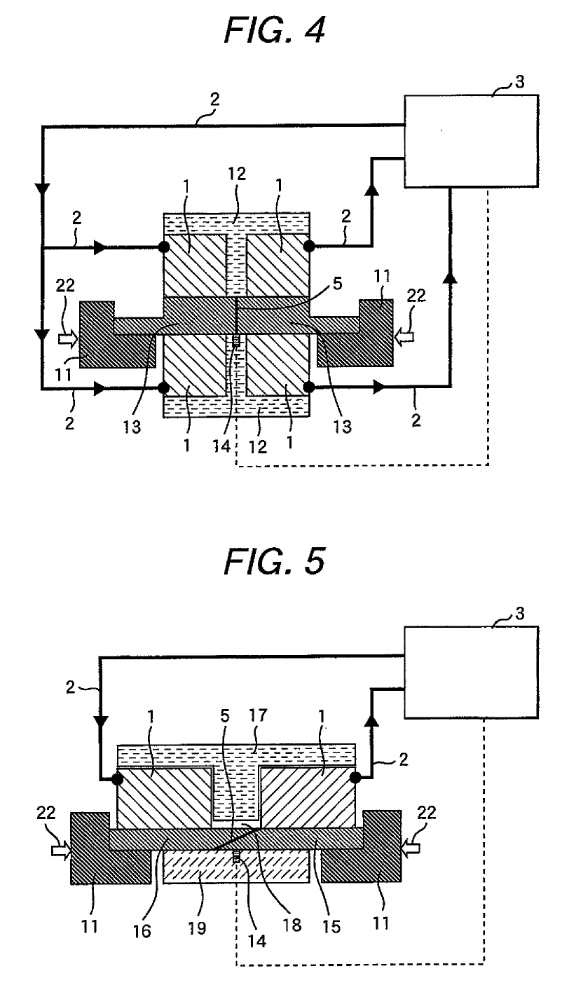

FIG. 4 shows the fourth embodiment, which illustrates two electro-conductive bonding members having a large cross sectional area change, electrodes, a pressing mechanism, a power supply and energizing paths. The bonding members, electrodes, and pressing mechanism are shown in cross sections.

In this embodiment, bonding members were Ti-6Al-4V alloy. The reference numeral 1 denotes electrodes, 2 energizing paths, 3 a power supply, 5 a bonding interface, 11 a pressing tool, 12 an insulator, 13 a different thickness member, 14 temperature measuring means, and 22 a pressing direction. The arrows in the drawing are directions of current flowing the energizing paths 2. In the drawing, the bonding members are shown in a cross sections. The different thickness members 13 are butted at the thick portions, and the bonding interface 5 was pressed at the thin portions of the different thickness members by the pressing tool 11 in the pressing direction of pressing 22.

Respective different thickness members 13 are provided with an upper electrode 1 and lower electrode 1 whereby the electrodes are in contact with the different thickness members 13 at their thick portions and supported by the different thickness members. The total contact area of the upper and lower electrodes is set to be larger than the bonding interface 5.

The upper and lower electrodes 1 are electrically insulated by the insulator 12 from each other. In this state, current is supplied from the upper and lower electrodes 1 in contact with the different thickness member at left hand to the upper and lower electrodes 1 in contact with the different thickness members at right hand to heat the thick portions of the different thickness members in the vicinity of the bonding interface 5. Since the thin portions of the different thickness members are not energizing paths, resistance heat generation does not occur. Accordingly, temperature of the thin portions simply increases by thermal conduction from the thick portions, and the temperature of the thin portions does not exceed that of the thick portions.

The surface temperature at the bonding interfaces is measured by the temperature measuring means 14, and heating the bonding members to be bonded to a predetermined temperature lower than the solidus temperature thereby accomplish the diffusion bonding in a solid state. After the bonding, the sectional observation of the bonding interfaces was conducted to find no gaps at the interface of the bonding members and to find good bonding.

In this embodiment, the bonding members were Ti-6Al-4V alloys; other electro-conductive materials can be employed. The bonding members can be different. Other members can be sandwiched between the different thickness members 13 to carry out the bonding simultaneously.

In this embodiment, since the electrodes are independent from the pressing mechanism, and since arrangement of the electrodes is not restricted to a pressing axis of the pressing mechanism, it is possible to change the arrangement of the electrodes in accordance with the contour of the bonding members. Thus, a sufficient contact area between the electrodes and the bonding members is secured. As a result, a temperature of the contact portions between the electrodes and the bonding members can be set to be lower than that of the bonding members during heating the bonding members, and a current diffusion is carried out without causing melting of the contact portions between the electrodes and the bonding members.

### Embodiment 5

In carrying out bonding of materials such as aluminum alloys, magnesium alloys, etc, which have stable oxide films around the solid phase line of the materials, a sufficient bonding strength was not obtained by conventional diffusion bonding methods when the oxide films are present in the bonding interfaces.

In the fifth embodiment, the bonding members with oxide films in the surfaces were bonded with the same type of materials or different type of materials. In a state where a bonding portion is heated by current supply, a pressing force was applied to the bonding interfaces by the pressing mechanism in a tangential direction and the bonding members were moved in relative directions thereby to effect plastic deformation phenomenon by friction so as to mechanically destroy the oxide films present in the surfaces of the bonding members and exposes new surfaces of the alloys.

FIG. 5 shows the fifth embodiment of the present invention. In the drawing, there are shown electro-conductive bonding members having stable oxide films in the surfaces thereof, electrodes, a pressing mechanism, a power supply and energizing paths. In this embodiment, the bonding members were dissimilar metals, i.e. A2618 and AZ91.

In the drawing, the reference numeral 1 denotes electrodes (cross section), 2 energizing paths, 3 the power supply, 5 bonding interfaces, 11 the pressing tool, 14 the temperature measuring means, 15 the butting member of A2618, 16 the butting member of AZ91, 17 a press mold, 18 an interspace for plastic deformation, 19 a fixed mold, and 22 the pressing direction. The arrows in the drawing are directions of current flow in the energizing paths.

The bonding member in the drawing are a cross sectional view; A2618 butting member 15 and AZ91 butting member 16 are butted. The bonding interface 5, which is inclined with respect to a pressing direction, is pressed by the pressing tool 11. One electrode 1 is disposed to one butting member wherein the upper faces of the butting members are in contact with the electrodes.

There is the press mold disposed above the bonding portion and located between the electrodes 1, the press mold being electrically insulated from the energizing paths 2. The press mold 17 is provided with a space 18 for receiving plastic deformation.

On the other hand, the lower face of the butting members is provided with a fixing mold 19, which is electrically insulated from the energizing paths 2. In this state, current is supplied from the electrode 1 in contact with the left hand butting member 16 of AZ91 to the electrode 1 in contact with the right hand butting member 15 of A2618 to heat the neighborhood of the bonding interface 5. The surface temperature of the bonding portion was measured by the temperature measuring means 14, thereby to heat the bonding members to a predetermined temperature, which is lower than the solidus temperature of the bonding members. As a result, the material of the bonding members in the vicinity of the bonding interface 5 was softened and plastic deformation was caused by a pressing force with the pressing tool 11.

The butting member 16 of AZ91 flows plastically into the space 18 and the butting member 15 of A2618 flows plastically below the butting member 16. When the space 18 is closed from the atmosphere, a volume of the member that can move plastically. Therefore, an excessive deformation is prevented. In this stage, friction between the bonding members due to displacement thereof takes place in the bonding interface 5 to break the oxide films present in the surfaces in the bonding interface 5 and expose new surfaces.

Since the bonding portion is in a heated state, diffusion of atoms between the bonding members to bond the new surfaces. The cross section of the bonding portion was observed after bonding; it was revealed that there were no gaps at the bonding interface and bonding was good.

In this embodiment, the bonding members were A2618 and AZ91; the member, wherein the latter flows into the interspace for plastic deformation was AZ91 having a low melting point, plastic flow easily took place. Kinds of members may be other materials or the materials of the members may be the same.

The bonding interface 5 inclined with respect to the pressing direction by the pressing tool 11 is preferable because friction in the bonding interface due to plastic flow effectively works. It is possible to adjust or change the arrangement of the electrodes 1 and the space 18 in accordance with contours of the members, thereby to alter the temperature distribution in the neighborhood of the bonding interface, the directions and degree of plastic deformation by pressing.

In the above embodiment, the interspace for plastic deformation 18 is formed in one side of the bonding interface, but the space may be formed in both sides. One or both of the members may be provided with recesses in the bonding interface to form the interspace for plastic deformation.

According to this embodiment, even when the bonding members to be diffusion bonded have the oxide films in the bonding interface, which is stable at a temperature just below the solidus temperature, the oxide film is broken by plastic deforming the bonding portion during bonding by friction of the bonding portion thereby to reduce an amount of oxide remaining in the bonding interface. As a result, the bonding strength is increased to a satisfactory strength.

### Embodiment 6

In the sixth embodiment a plate form member having an oxide film on the surface thereof was bonded with a member of the same type material as the plate form member or another type material. The plate form members were stacked and current was supplied to the stack. A shear deformation in a direction traversing the contact interface was applied by the pressing mechanism to expose newly-formed faces, while the neighborhood of the stacked portions of the members was heated. As a result, newly-formed faces were bonded by resistance bonding.

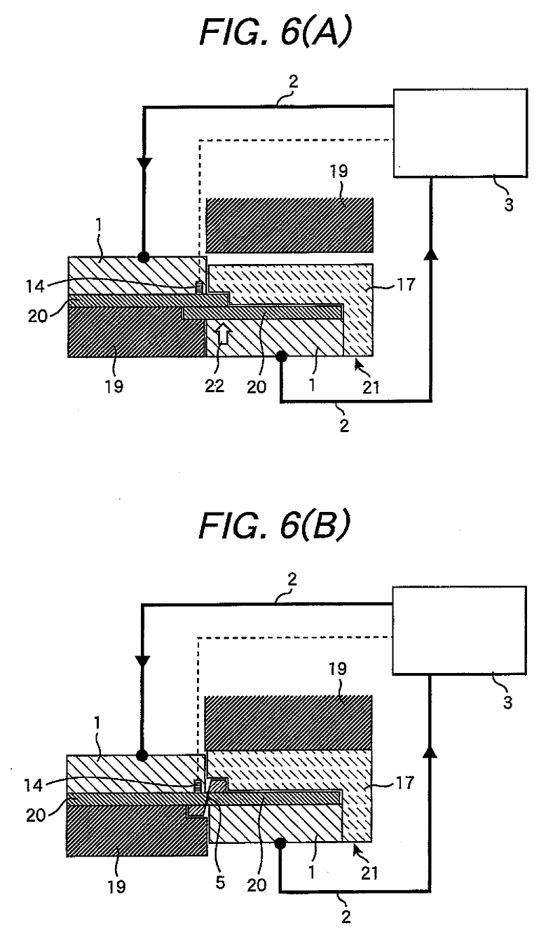

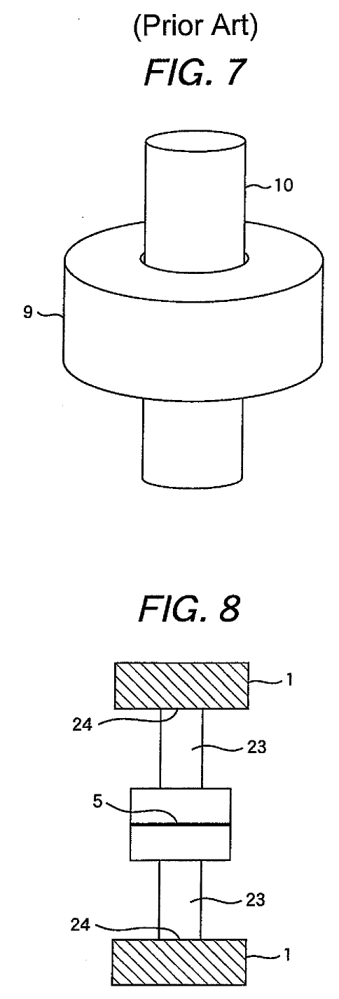

FIGS. 6(A) and 6(B) show the sixth embodiment. There are shown two plate form bonding members having an oxide film on the surfaces thereof, electrodes, a pressing mechanism, a power supply and energizing paths. The bonding members and electrodes are shown in cross sections.

In this embodiment, the bonding members were zirconium base amorphous alloys. The reference numeral 1 denotes electrodes 1 (cross section), 2 energizing paths, 3 a power source, 5 a bonding interface, 14 temperature measuring means, 17 a press mold, 19 a fixing mold, 20 plate form members, 21 a shear press mold assembled by the electrodes and the press mold and 22 a pressing direction. The arrows in the drawing are directions of current flow in the energizing paths.

FIG. 6(A) shows a state of current supply start. The plate form members were stacked and held by the press mold 19, electrodes 1, and the shear press mold 21. The electrodes 1 and the press mold 17, which constitute the shear press mold are electrically insulated from each other. The shear press mold 21 can move upward in FIGS. 6 (A) and 6 (B). The shear press mold 21 can move until it touches the press mold 19, which is located above the mold 19 with a predetermined distance. By adjusting the distance between the shear press mold 21 and the press mold 19, the moving distance of the press mold 19 becomes variable. In this embodiment, the distance was set to be the same as the thickness of the plate form member.

In this stage, current was supplied from the electrode 1 in contact with the left hand plate form member 20 to the electrode 1 in contact with the right hand plate form member 20 to heat the neighborhood of the contact portions. The surface temperature of the stacked portion was measured by the temperature measuring means 14 to control the temperature of the members to be the temperature lower than the crystallization temperature of the amorphous alloy. As a result, the member in the neighborhood of the contact portion softens. At this stage, the members were pressed by the shear press mold 21 to impart shear deformation to the stacked portions of the plate form members.

FIG. 6(B) shows the state where the shear press mold moves to deform the stacked portions by shearing. By shear deformation, newly-formed faces of the plate form members are exposed to become the bonding interface 5. At this stage, bonding was performed by plastic bonding, but further current supply for a predetermined time effects diffusion of atoms in the bonding interface 5 to enhance the bonding strength. After the bonding, the cross section of the bonding interface was observed, and it was revealed that there were no gaps and almost no oxide films at the bonding interface and good bonding was obtained.

In this embodiment the bonding members were zirconium base alloys, but other electro-conductive materials. The members may be a combination of different materials. When the shear press mold 21, the electrodes 1 and the press mold 19 are given a contour for performing press working, the bonding and pressing are carried out simultaneously.

### Embodiment 7

According to a conventional resistance diffusion bonding method, bonding is carried out by heating bonding members to predetermined temperatures for respective materials. Since the temperature ranges are higher than ½ the solidus temperatures, characteristics of the material may be greatly damaged by crystallization of the amorphous alloys, for example.

In this embodiment, the bonding members were subjected to shear deformation or shearing plastic deformation by pressing at a temperature at which characteristics are not deteriorated as same as in the previous embodiments. The complete bonding was carried out in a solid state during heating the bonding members to the bonding temperature, while maintaining the characteristics that the materials naturally have.

According to this embodiment, a large shear deformation is given the bonding members heated to a temperature lower than the crystallization temperature to expose new surfaces in the bonding interfaces to perform bonding without losing the natural characteristics, even when the bonding members may drastically change their characteristics above the crystallization temperature.

According to the embodiments of the present invention, it is possible to firmly bond the members even when the bonding members have complicated contours.

The present invention can be applied to bonding different materials for mechanical parts of automobiles, impellers or hydraulic circuits for general industrial machinery, forming cooling channels for metal molds for casting or resin molding.

What is claimed is:

1. A resistance bonding method for bonding electro-conductive members in contact with each other under pressure by supplying current from plural electrodes, which comprises applying a pressure to a contact interface between the members in such a manner that a space having a predetermined shape in at least part of a neighborhood of the contact interface and part of the members is moved into the space by a stress thereby bonding the members.

2. A resistance bonding method for bonding electro-conductive members in contact with each other, which comprises the members are bonded by supplying current from electrodes, wherein at least one of the members is provided with a recess in a contact interface.

3. A resistance bonding method for bonding electro-conductive members in contact with each other by supplying current to the members from electrodes, wherein one of the members is a structural member provided with a groove of a predetermined contour in a contact interface; and part of the members softened by resistance heating is deformed by a pressure thereby to effect plastic flow into the groove.

4. A resistance bonding method for bonding electro-conductive members in contact with each other by supplying current to the members, wherein the members, at least part of the members being overlapped, are clamped in press machines, which are arranged opposite to each other, and current is supplied through the overlapped members, thereby to heat at least the overlapped portions, and the overlapped portion is subjected to shear deformation.

5. A resistance bonding apparatus comprising current supply means having a plurality of electrodes, a current power device for supplying current between desired electrodes of the plural electrodes, and pressurizing means for imparting a bearing stress to a bonding interface between the members, wherein at least one of the electrodes is in contact with at least one of the members, the current supply means being provided with temperature measuring means for measuring a surface temperature of the members, a switching means for moving a position of the pressurizing means in response to information on the surface temperature of the members, and the pressurizing means having a mechanism that moves towards the bonding interface.

6. The resistance bonding apparatus according to claim 5, wherein the switching means accelerates the pressurizing means when the information on the surface temperature is a solidus temperature or lower than the solidus temperature.

7. The resistance bonding apparatus according to claim 5, wherein the pressurizing means has a press mold having a recess into which a part of the members is filled by plastic deformation, when the pressurizing means is moved while being in contact with the bonding interface.

8. The resistance bonding apparatus according to claim 5, wherein the pressing device has a recess into which a part of the members is filled by plastic deformation.

9. The resistance bonding apparatus according to claim 6, wherein the pressurizing means has a press mold having a recess into which a part of the members is filled by plastic deformation, when the pressurizing means is moved in contact with the bonding interface.

10. The resistance bonding apparatus according to claim 6, wherein the pressurizing means has a recess into which a part of the members is filled by plastic deformation.
